(19) United States
(12) Patent Application Publication
(10) Pub. No.: US 2007/0021545 A1
(43) Pub. Date: Jan. 25, 2007

(54) Polyacrylate-containing adhesive mass and article corresponding hotmelt processing method

(75) Inventors: Marc Husemann, Hamburg (DE); Stephan Zollner, Hamburg (DE)

Correspondence Address: NORRIS, MCLAUGHLIN & MARCUS, P.A., 875 THIRD AVE, 18TH FLOOR, NEW YORK, NY, 10022, US

(73) Assignee: Tesa AG, Hamburg (DE)

(21) Appl. No.: 10/558,225

(22) PCT Filed: May 30, 2003
(86) PCT No.: PCT/EP03/05682

§ 371 Date: Sep. 22, 2006

(51) Int. Cl. C08K 3/22

(52) U.S. Cl. 524/431; 524/556; 524/555; 524/430; 524/432

(57) ABSTRACT

Pressure-sensitive adhesive comprising a polyacrylate prepared by polymerizing a monomer mixture comprising N-tert-butylacylamide, and subsequently mixing with a mono- or di-valent salt.

The invention relates to polyacrylate-containing pressure-sensitive adhesives having good cohesion and also to pressure-sensitive adhesive articles produced therewith, especially adhesive tapes and adhesive sheets. The invention pertains as well to an altered hotmelt processing method.

As a result of ever greater environmental strictures and pressure on costs, a trend is afoot at present toward the production of pressure-sensitive adhesives (PSAs) without, or with very small amounts of, solvent. This objective is most easily realized by means of the hotmelt technology. A further advantage of this technology is the shortening in production time. Hotmelt lines are able to laminate adhesives significantly more quickly onto backings or release paper and so to save time and money.

For the production of acrylate hotmelts, conventionally, acrylate monomers are polymerized in solution and then the solvent is removed in a concentration operation in an extruder.

The hotmelt technology, however, imposes exacting requirements on the adhesives. For high-value industrial applications there is preference in particular for polyacrylates, on account of their transparency and weathering stability. As well as these advantages, however, these acrylate PSAs must also meet exacting requirements in the area of shear strength. This is achieved by means of polyacrylates with high molecular weight, high polarity, and subsequent efficient crosslinking.

The high-shear-strength polar PSAs, however, possess the disadvantage that they are not highly suited to the hotmelt extrusion operation, given the need for high application temperatures and the reduction in molecular weight as a result of shearing in the extruder. Owing to the high polarity and high molecular weight, the bond strength of these adhesives is low and their tack is relatively low. It is therefore most easy to process polyacrylates containing relatively apolar comonomers and having a low average molecular weight. Here, however, there is the problem of the very low cohesion (shear strength).

The processing of acrylic hotmelts in principle is known for example from Dutch pat. 6 606 711 and 7 009 629. The cohesion can be increased within certain limits by efficient UV crosslinking on the backing. For example, Guse et al. (DE 2 743 979 (1977)) copolymerized benzoin acrylate comonomers into the acrylate hotmelt and crosslinked post-coating with UV radiation directly on the backing. A similar path to the production and processing of acrylate hotmelts was by Rehmer et al. in U.S. Pat. No. 5,073,611. There, benzophenone and acetophenone as acrylated photoinitiator were incorporated into the acrylate polymer chain, followed by UV crosslinking.

Another method of efficiently crosslinking acrylate PSAs is that of copolymerization of acrylates containing electron-donating groups. These stabilize free radicals, which form during crosslinking, and hence, after appropriate irradiation with UV or EBC, achieve high degrees of crosslinking. Examples thereof are the tetrahydrofuryl acrylates used by Rehmer et al. [EP 343,467 B1 (1989)], monomers containing tertiary amines [Ang et al. in WO 96/35725 (1995)], and tertiary N-butylacrylamide as monomer [U.S. Pat. No. 5,194,455, Massow et al. (1990)].

In this way it is possible to obtain, for example, EB-crosslinkable polyacrylate hotmelt PSAs with a high cohesion, but efficient crosslinking requires a relatively high electron beam dose, which in turn may damage the backing material in the PSA tape, or the release liner. Moreover, high efficiency in the case of EB crosslinking is achieved with polyacrylates having high average molecular weight.

Although the high NTBAM fraction does likewise raise the cohesion, as a result of an increase in the glass transition temperature, the flow viscosity for the hot melt operation also rises. Consequently, NTBAM can be used only within certain limits to raise the glass transition temperature and to lower the EBC dose for crosslinking.

It is an object of the invention, therefore, to provide high-shear-strength polyacrylate PSAs having sufficiently low flow viscosity for hotmelt processing to PSA articles but which at the same time exhibit effective cohesion and can be gently EB-cured.

Surprisingly it has been found that the blending of NTBAM-containing, pressure-sensitively adhesive polyacrylate compositions with monovalent or divalent metal salts at the same increases the shear strength and allows a reduction in the EBC dose. The flow viscosity of the PSAs of the invention during the hotmelt operation remains sufficiently unchanged as a result of blending with the metal salts.

It is true that U.S. Pat. No. 4,354,008 from National Starch and U.S. Pat. No. 4,360,638 from Rohm and Haas already describe the blending of acrylate PSAs with monovalent and divalent salts and disclose the reversible chelating action of metal salts in connection with beta-hydroxypropyl (metha)acrylate esters (National Starch) and o-methoxy-substituted aryl acids. As a result of the metal salts, the flow viscosity is lowered at high temperatures and the shear strength is raised at room temperature. In both cases, nevertheless, the shear strength achieved is relatively low, since the adhesives described are not intended for a UV or EBC crosslinking, which raises the cohesion of a PSA even at relatively high temperatures.

The invention is based on the finding that the preparation of a high-shear-strength acrylate PSA suitable for the hotmelt operation is possible with advantage by virtue of this adhesive comprising NTBAM as a electron-donating component and, for the synergistic effect, simultaneously, a monovalent or divalent metal salt as chelating reagent. Through the electron-donating component, NTBAM facilitates EB curing on the backing. The metal salts produce an increase in the dynamic glass transition temperature and the shear strength, but also lower the EBC dose required for optimum crosslinking. The characteristics of this method are described in detail in the text below.

This invention encompasses the blending of NTBAM-containing acrylate PSAs, especially acrylate hotmelts, with monovalent or divalent salts.

The PSAs of the invention comprise to an extent of at least 50% polymers having the following composition, the polymers having been prepared conventionally via a free or controlled radical addition polymerization:
(A) acrylic acid and methacrylic acid derivatives, with a fraction of 42-96.5 percent by weight,
   CH₂═CH(R₁)(COOR₂) (1)
   where R₁=H or CH₃ and R₂=an alkyl chain having 1-20 carbon atoms;
(B) vinyl compounds, acrylates, methacrylates containing at least one carboxylic acid group, with a fraction of 0.5 to 8 percent by weight,
(C) vinyl compounds containing functional groups, such as hydroxyl groups, sulfonic acid groups, ester groups, anhydride groups, epoxy groups, photoinitiators, amide groups, amino groups, with aromatics, heteroaromatics, heterocycles, ethers, etc., with a fraction of 0-30 percent by weight,
(D) N-tert-butylacrylamide, with a fraction of 3-20 percent by weight;
   and also an effective addition of a monovalent or divalent metal salt which is soluble in the corresponding polymer.

Monovalent or divalent metal salts include, among others, oxides, hydroxides or alkoxides. The salts come with particular preference from groups I A, II A, II B, I B and IV B of the Periodic Table and are added preferably in a ratio of 1:5 to 5:1 with respect to the respective molar fraction of carboxylic acid in the polymer.

Normally 0.25 up to a maximum of 8 weight fractions are added to the polyacrylate, the preferred range being situated between 3 and 6 weight fractions.

Metals employed are preferably lithium, sodium, potassium, calcium, magnesium, titanium, zinc, zirconium, barium, cadmium, strontium, the metal salts being used in the form of oxides, hydroxides, alkoxides, in the form of basic, acidic or neutral salts, it being necessary in each case for the fundamental requirement of solubility in the respective polymer to be met.

Further examples of salts which can be used in accordance with the invention are organic salts, such as zinc acetate and magnesium citrate. Further organic counterions which can be employed include glutamates, formates, carbonates, silicates, glycoates, octoates, gluconates, oxylates, and lactates.

Preferred metal compounds used are zinc(II) chloride, potassium iodide, and calcium(II) bromide.

The monomers for preparing the polyacrylate PSAs are preferably chosen such that the resulting polymers can be used as PSAs at room temperature or higher temperatures, particularly such that the resulting polymers possess pressure-sensitive adhesion properties in accordance with the “Handbook of Pressure Sensitive Adhesive Technology” by Donatas Satas (van Nostrand, New York 1989).

In a further inventive interpretation the comonomer composition is chosen such that the PSAs can be employed as heat-activable PSAs.

In one very preferred way use is made as monomers (A) of acrylic or methacrylic monomers which are composed of acrylic and methacrylic esters with alkyl groups of 4 to 14 carbon atoms, preferably 4 to 9 carbon atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as isobutyl acrylate, 2-ethylhexyl acrylate, 2-ethylhexyl methacrylate, isooctyl acrylate, isooctyl methacrylate. Further classes of compound to be used are monofunctional acrylates and/or methacrylates of bridged cycloalkyl alcohols, consisting of at least 6 carbon atoms. The cycloalkyl alcohols may also be substituted. Specific examples are cyclohexyl methacrylates, isobornyl acrylate, isobornyl methacrylates, and 3,5-dimethyladamantyl acrylate.

In one preferred interpretation use is made as monomers (B) of acrylic acid and methacrylic acid. Further preferred examples are itaconic acid, β-acryloyloxypropionic acid, trichloroacrylic acid, fumaric acid, crotonic acid, aconitic acid, dimethylacrylic acid or vinylacetic acid, this enumeration not being conclusive.

In one procedure use is made as monomers (C) of vinyl compounds, acrylates and/or methacrylates which carry polar groups such as carboxyl radicals, sulfonic and phosphonic acid, hydroxyl radicals, lactam and lactone, N-substituted amide, N-substituted amine, carbamate, epoxy, thiol, alkoxy, cyano radicals, ethers, halides or the like.

Moderate basic monomers are, for example, N,N-alkyl-substituted amides, such as N,N-dimethylacrylamide, N,N-dimethylmethylmethacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(buthoxymethyl)methacrylamide, N-methylolacrylamide, N-(ethoxymethyl)acrylamide, and N-isopropylacrylamide, this enumeration not being conclusive.

Further preferred examples as monomers (C) are hydroxyethyl acrylate, hydroxypropyl acrylate, hydroxyethyl methacrylate, hydroxypropyl methacrylate, allyl alcohol, maleic anhydride, itaconic anhydride, glyceridyl methacrylate, phenoxyethyl acrylate, phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, and tetrahydrofurfuryl acrylate, this enumeration not being conclusive.

In a further very preferred procedure use is made as monomers (C) of vinyl esters, vinyl ethers, vinyl halides, vinylidene halides, vinyl compounds with aromatic rings and heterocycles in a position. Here again, mention may be made, non-exclusively, of some examples: vinyl acetate, vinylformamide, vinylpyridine, ethyl vinyl ether, vinyl chloride, vinylidene chloride, and acrylonitrile.

Furthermore, in a further procedure, photoinitiators having a copolymerizable double bond are used as monomers (C). Suitable photoinitiators are Norrish I and II photoinitiators. Examples are, for example, benzoin acrylate and an acrylated benzophenone from UCB (Ebecryl P 36®). In principle it is possible to copolymerize all photoinitiators that are known to the skilled worker and are able to crosslink the polymer via a free-radical mechanism under UV irradiation. A review of possible photoinitiators which can be used and which can be functionalized with a double bond is given in Fouassier: “Photoinitiation, Photopolymerization and Photocuring: Fundamentals and Applications”, Hanser-Verlag, Munich 1995. As an extra, reference may be made to Carroy et al. in “Chemistry and Technology of UV and EB Formulation for Coatings, Inks and Paints”, Oldring (Ed.), 1994, SITA, London.

In a further preferred procedure the monomers (A) and (B) described are admixed with copolymerizable compounds (C) which possess a high static glass transition temperature. Suitable components include aromatic vinyl compounds, such as styrene, the aromatic nuclei being composed preferably of C₄ to C₁₈ units and being also able to contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, tert-butylphenyl acrylate, tert-butylphenyl methacrylate, 4-biphenylyl acrylate and methacrylate, 2-naphthyl acrylate and methacrylate, and mixtures of those monomers, this enumeration not being conclusive.

In order to achieve a polymer glass transition temperature T_{g} which is preferred for PSAs, of T_{g}≦25° C., in accordance with the remarks above, the monomers are very preferably selected, and the quantitative composition of the monomer mixture advantageously chosen, in such a way that the Fox equation (E1) (cf. T. G. Fox, Bull. Am. Phys. Soc. 1 (1996) 123) produces the desired T_{g} value for the polymer.

$$\frac{1}{{T}_{g}} = {\sum }_{n} \frac{{w}_{n}}{{T}_{g , n}} \qquad ( E1 )$$

In this equation, n represents the serial number of the monomers used, wₙ the mass fraction of the respective monomer n (% by weight), and T_{g,n} the respective glass transition temperature of the homopolymer of the respective monomer n, in K.

For preparing the poly(meth)acrylate PSAs it is advantageous to carry out conventional free-radical addition polymerizations. For the polymerizations which proceed by a free-radical mechanism it is preferred to use initiator systems additionally containing further free-radical initiators for the polymerization, especially thermally decomposing, free-radical-forming azo or peroxo initiators. In principle, however, all customary initiators that are familiar to the skilled worker for acrylates are suitable. The production of C-centered free-radicals is described in Houben Weyl, Methoden der Organischen Chemie, Vol. E 19a, pp. 60-147. These methods are preferably employed in analogy.

Examples of free-radical sources are peroxides, hydroperoxides, and azo compounds; as a number of non-exclusive examples of typical free-radical initiators, mention may be made here of potassium peroxodisulfate, dibenzoyl peroxide, cumene hydroperoxide, cyclohexanone peroxide, di-tert-butyl peroxide, azodiisobutyronitrile, cyclohexylsulfonyl acetyl peroxide, diisopropyl percarbonate, tert-butyl peroctoate, benzpinacol. In one very preferred interpretation use is made as free-radical initiator of 1,1′-azobis(cyclohexanecarbonitrile) (Vazo 88® from DuPont) or azodiisobutyronitrile (AIBN).

The average molecular weights M_{w} of the PSAs formed in the free-radical polymerization are very preferably chosen such that they lie within a range from 200 000 to 4 000 000 g/mol; specifically for further use as hotmelt PSAs, PSAs are prepared which have average molecular weights M_{w} of 400 000 to 1 200 000 g/mol. The average molecular weight is determined by size exclusion chromatography (GPC) or by matrix-assisted laser-desorption/ionization coupled with mass spectrometry (MALDI-MS).

The polymerization can be carried out in bulk (without solvent), in the presence of one or more organic solvents, in the presence of water, or in mixtures of organic solvents and water. The aim in this case is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether) and ethers (e.g., diethyl ether, dibutyl ether) or mixtures thereof. The aqueous polymerization reactions may have a water-miscible or hydrophilic cosolvent added to them in order to ensure that the reaction mixture during monomer conversion is in the form of a homogeneous phase. Cosolvents which can be used with advantage for the present invention are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organosulfides, sulfoxides, sulfones, alcohol derivatives, hydroxyether derivatives, amino alcohols, ketones, and the like, and also derivatives and mixtures thereof.

Depending on conversion and temperature the polymerization time amounts to between 2 and 72 hours. The higher the reaction temperature that can be chosen, in other words the higher the thermal stability of the reaction mixture, the lower the level at which the reaction time can be chosen.

To initiate the polymerization it is essential, for the thermally decomposing initiators, to introduce heat. For the thermally decomposing initiators the polymerization can be initiated by heating to 50 to 160° C., depending on initiator type.

For the preparation it may also be of advantage to polymerize the acrylate PSAs in bulk (without solvent). In this case it is particularly suitable to use the prepolymerization technique. The polymerization is initiated with UV light but taken only to a low conversion of about 10%-30%. Subsequently this polymer syrup can be welded, for example, into films (in the simplest case, ice cubes) and then polymerized through in water to high conversion. These pellets can then be used as acrylate hotmelt adhesives; for the melting operation it is particularly preferred to use film materials which are compatible with the polyacrylate.

Another advantageous preparation process for the poly(meth)acrylate PSAs is anionic polymerization. Here the reaction medium used preferably comprises inert solvents, such as aliphatic and cycloaliphatic hydrocarbons, or else aromatic hydrocarbons.

The living polymer in this case is generally represented by the structure P_{L}(A)-Me, where Me is a metal from group I, such as lithium, sodium or potassium, and P_{L}(A) is a growing polymer formed from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium or octyllithium, this enumeration possessing no claim to completeness. Furthermore, initiators based on samarium complexes are known for the polymerization of acrylates (Macromolecules, 1995, 28, 7886) and can be used here.

Furthermore, it is also possible to use difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides or alkylaluminum compounds. In one very preferred version the ligands and coinitiators are chosen such that acrylate monomers, such as n-butyl acrylate and 2-ethylhexyl acrylate, can be polymerized directly and do not have to be generated in the polymer by transesterification with the corresponding alcohol.

For the preparation of polyacrylate PSAs with a narrow molecular weight distribution, controlled free-radical polymerization methods are also suitable.

As a controlled free-radical polymerization method it is possible for example to carry out nitroxide-controlled polymerizations. Radical stabilization is effected in a favorable procedure using nitroxides of type (Va) or (Vb): 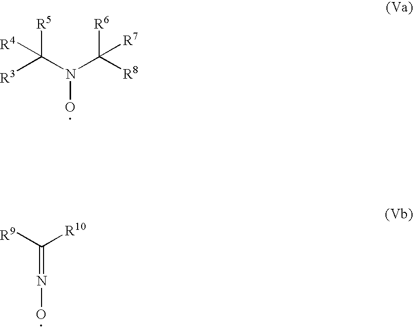
where R³, R⁴, R⁵, R⁶, R⁷, R⁸, R⁹, and R¹⁰ independently of one another denote the following compounds or atoms:
i) halides, such as chlorine, bromine or iodine
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂,
   where R¹¹, R¹² or R¹³ stand for radicals from group ii).

Compounds of (Va) or (Vb) may also be attached to polymer chains of any kind (primarily in the sense that at least one of the abovementioned radicals constitutes a polymer chain of this kind) and can therefore be used to construct polyacrylate PSAs.

More preferred are controlled regulators for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-tert-butyl-PROXYL, 3,4-di-tert-butyl-PROXYL
2,2,6,6-tetramethyl-1-piperidinyloxypyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl1-phenyl-2-methylpropyl nitroxide
N-tert-butyl1-(2-naphthyl)-2-methylpropyl nitroxide
N-tert-butyl1-diethylphosphono-2,2-dimethylpropyl nitroxide
N-tert-butyl1-dibenzylphosphono-2,2-dimethylpropyl nitroxide
N-(1-phenyl-2-methylpropyl)-1-diethylphosphono-1-methylethyl nitroxide
di-tert-butyl nitroxide
diphenyl nitroxide
tert-butyl tert-amyl nitroxide.

A series of further polymerization methods by which the PSAs can be prepared in alternative procedure can be chosen from the prior art:

U.S. Pat. No. 4,581,429 A discloses a controlled-growth free-radical polymerization process which employs as its initiator a compound of the formula R′R″ N—O—Y, wherein Y is a free radical species which is able to polymerize unsaturated monomers. The conversion rates of the reactions, however, are generally low. A particular problem is the polymerization of acrylates, which proceeds only at very low yields and molar masses. WO 98/13392 A1 describes open-chain alkoxyamine compounds which have a symmetrical substitution pattern. EP 735 052 A1 discloses a process for preparing thermoplastic elastomers with narrow molar mass distributions. WO 96/24620 A1 describes a polymerization process which used very specific free-radical compounds, such as phosphorus-containing nitroxides which are based on imidazolidine. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding onward developments of the alkoxyamines or of the corresponding free nitroxides improve the efficiency for the preparation of polyacrylates (Hawker, paper to the National Meeting of the American Chemical Society, Spring 1997; Husemann, paper to the IUPAC World Polymer Meeting 1998, Gold Coast).

As a further controlled polymerization method it is possible with advantage to synthesize the polyacrylate PSAs using atom transfer radical polymerization (ATRP), the initiator used comprising preferably monofunctional or difunctional secondary or tertiary halides and the halide(s) being abstracted using complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1): The various possibilities of ATRP are further described in documents U.S. Pat. No. 5,945,491 A, U.S. Pat. No. 5,854,364 A and U.S. Pat. No. 5,789,487 A.

For onward development it is possible to admix the inventive PSAs with resins. Tackifying resins for addition which can be used include, without exception, all tackifier resins that are already known and have been described in the literature. Representatives that may be mentioned include the pinene resins, indene resins, and rosins, their disproportionated, hydrogenated, polymerized and/or esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking, it is possible to use all resins that are compatible (soluble) with the polyacrylate in question; reference may be made in particular to all aliphatic, aromatic, and alkylaromatic hydrocarbon resins, hydrocarbon resins based on single monomers, hydrogenated hydrocarbon resins, functional hydrocarbon resins, and natural resins. Express reference is made to the description of the state of knowledge in the “Handbook of Pressure Sensitive Adhesive Technology” by Donatas Satas (van Nostrand, 1989).

Furthermore it is possible, optionally, for plasticizers, further fillers (for example, fibers, carbon black, zinc oxide, chalk, solid or hollow glass beads, microspheres of other materials, silica, silicates), nucleators, expandants, compounding agents and/or aging inhibitors, in the form for example of primary and secondary antioxidants or in the form of light stabilizers, to be added.

Additionally it is possible to admix crosslinkers and crosslinking promoters. Examples of suitable crosslinkers for electron beam crosslinking are difunctional or polyfunctional acrylates. Suitable crosslinkers are known in the prior art. Examples of crosslinkers which can be used include SR 610 (Sartomer), PETIA, PETA, Ebecryl 11 (UCB), and other polyfunctional acrylates and/or methacrylates, such as SR 350 from Sartomer.

To produce hotmelt PSA tapes the above-described polymers are coated preferably as hotmelt systems (in other words from the melt). For the production process it may therefore be necessary to remove the solvent from the PSA. Here it is possible in principle to use all of the methods that are known to the skilled worker. One very preferred method is that of concentration via a single-screw or twin-screw extruder. The twin-screw extruder may be operated co- or counterrotatingly. The solvent or water is distilled off preferably over two or more vacuum stages. Moreover, counterheating is carried out, depending on the distillation temperature of the solvent. The residual solvent fractions amount to preferably <1%, more preferably <0.5%, and very preferably <0.2%. The hotmelt is processed further from the melt.

In one preferred process the additions of metal salt are added shortly before concentration or are compounded in solid form into the hotmelt.

The acrylate PSAs blended in this way are applied in the form of a hotmelt to a backing (BOPP, PET, nonwoven, PVC, etc.) or release paper (glassine, HDPE, LDPE) and then crosslinked in order to increase the cohesion, preferably by EBC.

Typical irradiation equipment which may be employed includes linear cathode systems, scanner systems, and segmented cathode systems, where the equipment in question includes electron beam accelerators. An exhaustive description of the state of the art and the most important process parameters are found in Skelhorne, Electron Beam Processing, in Chemistry and Technology of UV and EB formulation for Coatings, Inks and Paints, Vol. 1, 1991, SITA, London. The typical acceleration voltages are situated in the range between 50 kV and 500 kV, preferably 80 kV and 300 kV. The scatter doses employed range between 5 to 150 kGy, in particular between 20, preferably 25 or 30 and 100 kGy.

Particularly for EBC a relatively low dose is required, owing to the above-described PSA, so that even new products with a high layer thickness on EBC sensitive backings can be crosslinked. Thus siliconized release papers are less damaged by EBC and the unwind forces of the corresponding PSA tape remain virtually constant. In this way it is possible to produce transfer tapes very easily.

Adhesive performance testing shows an increased cohesion, not only at room temperature but also at 80° C., with a low EBC dose at the same time. Although it could in principle be omitted, with impairment of the exemplary embodiments, EB curing is nevertheless urgently recommended for the generation of high-shear-strength PSA tapes, with a lowering in the dose or EB curing being possible.

Furthermore, the shear strength of the individual PSAs is improved even at relatively high EBC doses. Reducing the EBC dose minimizes the problem of liner damage. Otherwise, in the case of high marginal doses on the release paper surface, damage occurs which hinders unwinding of PSA tape. The PSA tape can be used only with very great application of force, or not at all. Reducing the EBC dose enables a reduction to be made in the interfacial dose on the backing material, so that the liner is damaged to a significantly reduced extent and is able to continue to function effectively as a release material. This phenomenon is also observed on BOPP and PVC backings. PVC backings undergo severe discoloration under electron beams, so that here as well a reduction in the EB dose is desirable. BOPP backings are likewise completely destroyed by EB at high doses.

As a result of the measures according to the invention therefore, it is possible to produce new, acrylate-based PSA tape products which it was hitherto possible to obtain only with difficulty or in a significantly poorer quality, such as, for example, fixing tabs with a high application rate of more than 100 g/m². The PSAs of the invention exhibit good cohesion. The additions of metal salt can also be varied. As well as the salts tested, a multiplicity of different salts can also be employed, with the same effect, as the skilled worker is able to try out within the ambit of his or her skilled ability.

Furthermore, in principle, not only pure acrylate PSAs but also blended PSAs are suitable for blending with metal salts. Here again, the effect of cohesion increase in conjunction with lower EBC dose is observed. PSAs can be blended with crosslinkers, with plasticizers, with a multiplicity of resins and fillers. Examples of this are given below.

The invention is described in more detail below with reference to examples. Reference is also made herein to figures, which show the following:

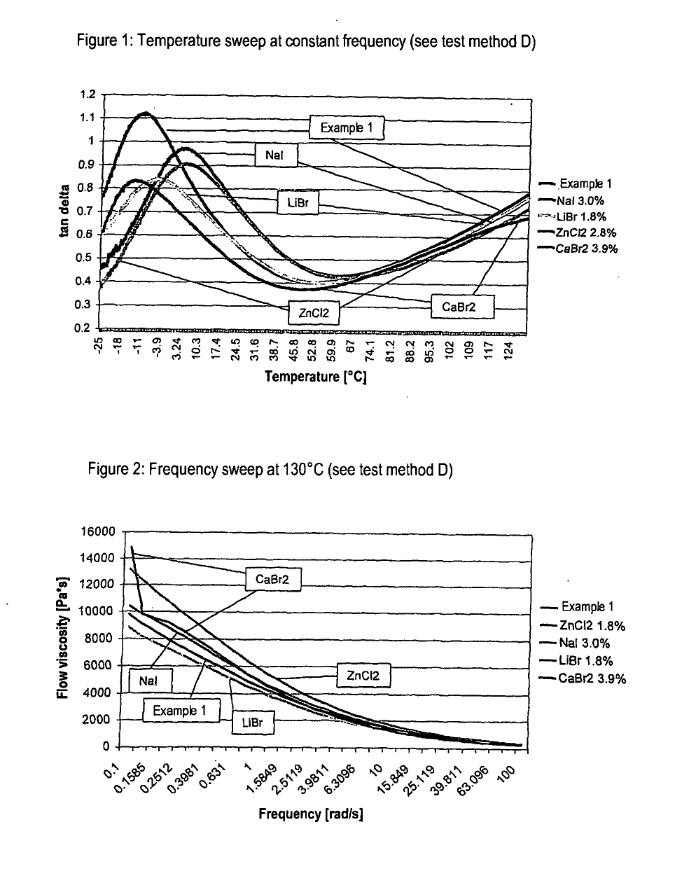

FIG. 1: Temperature sweep curves for determining the dynamic glass transition temperature of a pressure-sensitively adhesive polyacrylate based PSA with and without salt blending.

FIG. 2: Frequency sweep curves for rheometrically determining the flow viscosity temperature of a pressure-sensitively adhesive polyacrylate based PSA with and without salt blending.

### EXAMPLE SECTION

The aim of this invention is to produce high-shear-strength acrylate PSAs at low EBC dose for crosslinking on the backing. To this end, first of all, different polyacrylates with PSA properties were prepared. The polymers were prepared conventionally via a free radical polymerization in a 2-L glass reactor in acetone solvent. The polymers possessed the following composition (Tab. 1):

TABLE 1

| | AA | | | | |
|---|---|---|---|---|---|
| Example | [%] | 2-EHA [%] | n-BuA [%] | NTBAM [%] | MSA [%] |
| 1 | 2 | 44.5 | 44.5 | 8 | 1 |
| 2 | 1 | 86 | 0 | 12 | 1 |
| 3 | 3 | 60 | 30 | 6 | 1 |

all percentages in percent by weight

Examples 1, 2 and 3 contain a relatively low fraction of polar comonomers, such as acrylic acid. These polymers are therefore highly suitable for the hotmelt operation—not least owing to the low flow viscosity at relatively high temperatures. Instead, these polymers contain NTBAM as comonomer. NTBAM possesses electron donation properties and consequently promotes EB crosslinking through stabilization of free radicals. The synthesized examples 1-3 are regarded as starting adhesives and were therefore subjected to adhesive performance testing. For this testing, swatch specimens of the adhesives were produced, and were then crosslinked fully with different EBC doses, using an acceleration voltage of 230 kV. The application rate of the PSA on the release paper backing was 50 g/m² in each case. The precise testing methods are described in the annex.

TABLE 2

| | | | | | HP RT | HP 80° C. |
|---|---|---|---|---|---|---|
| | | Gel | BS-steel | Fracture | 10 N | 10 N |
| Example | EBC dose | fraction | [N/cm] | HP | [min] | [min] |
| 1* | 0 kGy | 0% | 5.9 | c | 35 | 3 |
| 1 | 20 kGy | 26% | 5.2 | c | 2025 | 10 |
| 2 | 20 kGy | 21% | 5.3 | c | 1650 | 10 |
| 3 | 20 kGy | 25% | 5.0 | c | 2580 | 25 |
| 1′ | 30 kGy | 55% | 4.8 | a | 7200 | 375 |
| 2′ | 30 kGy | 46% | 5.0 | c | 3675 | 145 |
| 3′ | 30 kGy | 51% | 4.8 | a | 5235 | 305 |
| Example 1* illustrates that to generate an adhesive having shear strength EB curing is essential. At a gel fraction of 0%, this adhesive fails very quickly, at 35 minutes at room temperature and 3 minutes in the hot shear test at 80° C. From table 2 it can also be gathered that at 20 kGy all samples are still undercrosslinked. At 21%-26%, the gel fraction is relatively low and the samples all fracture cohesively from the steel plate in the shear test. | | | | | | |
| # shear test. At room temperature, holding powers of 1650-2580 minutes are achieved with a 10 N shearing force. At 80° C. the cohesion decreases even more greatly, and the shear tests fracture cohesively after 10-25 minutes. For a product with greater shear strength, the EBC dose was increased by 50% from 20 to 30 kGy. With a significantly higher gel fraction, values at room temperature of 3675 to 7200 are now achieved. The holding powers in the hot | | | | | | |
| # shear test as well undergo improvement, to 145 to 375 minutes, although these values, considered in absolute terms, are still not high enough for a very high-shear-strength adhesive tape. | | | | | | |

For optimization, salts were admixed to these examples. The metal salts act as coordinators between the carboxylic acid groups and increase the dynamic glass transition temperature of the polymer. This effect is highly unusual, since in the case of a normal EB crosslinking the dynamic glass transition temperature is virtually independent of the degree of crosslinking. The increase ought therefore to produce a shift into the cohesive range, and ought to reduce the EBC dose required for optimum crosslinking. In order to test this effect, example 1 was first blended with different metal salts in different amounts, and this effect was investigated rheologically.

Table 3 again lists the individual blends. The percentages relate to proportions.

TABLE 3

| | Proportion of | |
|---|---|---|
| Example | example 1 | Metal salts |
| 1Na | 3.0 | NaI |
| 1Li | 1.8 | LiBr |
| 1Ca | 3.9 | CaBr₂ |
| 1Zn | 2.8 | ZnCl₂ |

First of all, temperature sweeps (see test method D) were carried out in order to determine the dynamic glass transition temperature of the starting substance example 1, and the blends made with it. FIG. 1 reveals the results:

NaI, LiBr and ZnCl₂ additions all show the same trend. As compared with the starting compound, example 1, the glass transition temperature increases to a desired extent. The effects differ in magnitude depending on metal salt and proportion. In comparison with this, CaBr₂ as an additive has a virtually opposite effect. The dynamic glass transition temperature falls a little as compared with example 1. In order to complete the rheological investigations, frequency sweeps at 130° C. were likewise conducted. The intention here was to determine the flow viscosity at a processing temperature which is relevant for the hotmelt process.

The results of these investigations are depicted in graph form in FIG. 2.

FIG. 2 reveals that, at a hotmelt processing temperature of 130° C., the flow viscosity increases in virtually all cases as a result of the addition of metal salt additives. Nevertheless, the effects are relatively small, particularly at frequencies with more than 1 rad/s. The sole exception is the addition with ZnCl₂ added. There the flow viscosity, with a low frequency, is somewhat below that of the base composition, from example 1. Owing to the low initial viscosity of example 1, however, all polymer blends are suitable for the hotmelt process.

The intention of the text below is to investigate first of all the adhesive performance effects of additizing as a function of the EBC dose. In the same way as for the initial composition, the adhesives were applied at an application rate of 50 g/m² to a siliconized release paper backing and then crosslinked with different EBC doses. The results are set out in table 4.

TABLE 4

| | | | | | HP RT | HP 80° C. |
|---|---|---|---|---|---|---|
| | | Gel | BS-steel | Fracture | 10 N | 10 N |
| Example | EBC dose | fraction | [N/cm] | HP | [min] | [min] |
| 1Li | 0 kGy | 0% | 5.8 | c | 45 | 3 |
| 1Na | 20 kGy | 23% | 5.1 | c | 7895 | 745 |
| 1Li | 20 kGy | 21% | 5.3 | c | 6540 | 515 |
| 1Ca | 20 kGy | 27% | 4.9 | c | 8580 | 1835 |
| 1Zn | 20 kGy | 29% | 5.2 | c | 10 000+ | 1050 |
| 1Na′ | 30 kGy | 49% | 4.8 | a | 10 000+ | 1590 |
| 1Li′ | 30 kGy | 48% | 4.9 | a | 10 000+ | 2035 |
| 1Ca′ | 30 kGy | 52% | 4.7 | a | 10 000+ | 10 000+ |
| 1Zn′ | 30 kGy | 54% | 4.9 | a | 10 000+ | 2580 |

A comparison of the unirradiated specimens 1Li* with 1* shows the relatively small effects of additization without EB curing. Even with 1.8% of LiBr the rapidity with which the adhesive 1Li* fails is similar both at room temperature and at 80° C. If, on the other hand, the blended adhesives are crosslinked with an EBC dose of 20 kGy, the gel values achieved are similar to those achieved without addition of metal salt (21%-29%). If, however, the holding powers are considered, and are compared with table 2, a distinct increase is apparent. With an EBC dose of 20 kGy and relatively low gel fractions of around 25%, the holding power level achieved here already corresponds to that of example 1 with a 30 kGy dose and a gel value of 55%. Consequently, the same level is achieved for an EBC dose which is lower by 50%. In some cases (e.g. ZnCl₂) significantly better holding powers are achieved with just 20 kGy, which correspond to the level of a high-shear-strength adhesive even at elevated temperatures of 80° C. For comparison purposes, the adhesives blended with metal salts were likewise irradiated with a dose of 30 kGy and adhesive performance tested. The gel values of 48%-54% show no significant difference in relation to adhesive 1′. In contrast, with the holding powers, an increased level was again realized. Particularly the holding powers with a shearing force of 10 N at 80° C. underwent a further significant improvement.

The aim of examples 2 and 3 was to investigate whether this effect also applies to other polyacrylates. In these latter examples, the focus was placed on the blends with CaBr₂, since this salt had shown the best results in the prior adhesive performance tests. The weight fractions employed are listed in table 5:

TABLE 5

| | Proportion of | |
|---|---|---|
| Example | examples 2 + 3 | Metal salt |
| 2Ca | 2.0 | CaBr₂ |
| 2Ca# | 4.0 | CaBr₂ |
| 3Ca | 5.8 | CaBr₂ |
| 3Ca# | 2.9 | CaBr₂ |

After blending, the adhesives were treated in the same way as for the example 1 blended with metal salts. Following lamination on the siliconized release paper backing, crosslinking was carried out with a dose of 20 and 30 kGy in each case, and these swatch specimens were then subjected to adhesive performance testing. The results of these tests are summarized in table 6.

TABLE 6

| | | | | | HP RT | HP 80° C. |
|---|---|---|---|---|---|---|
| | | Gel | BS-steel | Fracture | 10 N | 10 N |
| Example | EBC dose | fraction | [N/cm] | HP | [min] | [min] |
| 2Ca | 20 kGy | 22% | 5.2 | c | 3850 | 465 |
| 2Ca# | 20 kGy | 20% | 5.2 | c | 3645 | 450 |
| 2Ca′ | 30 kGy | 52% | 4.8 | a | 9890 | 2585 |
| 2Ca# | 30 kGy | 49% | 4.9 | a | 10 000+ | 2840 |
| 3Ca | 20 kGy | 25% | 4.9 | c | 5030 | 740 |
| 3Ca# | 20 kGy | 27% | 4.7 | c | 6215 | 625 |
| 3Ca′ | 30 kGy | 55% | 4.6 | a | 10 000+ | 4565 |
| 3Ca# | 30 kGy | 58% | 4.4 | a | 10 000+ | 3870 |

Comparing the results with the adhesive performance tests from table 2, a generally significant improvement is apparent in shear strength. In analogy to the results with example 1, significantly better holding powers are measured in turn for example 2 and 3 for a lower EBC dose. Even a comparison with the 30 kGy stage without addition of metal salt shows that with CaBr₂ the holding power level achieved is at least as good. Comparing the hot holding powers, they undergo a doubling (example 3) or trebling (example 2). Hence for examples 2 and 3 as well the addition of metal salt improves the shear strength of the PSAs even in the case of a lower EBC dose. When the dose is raised to 30 kGy, there is also an increase in the holding power level again for these examples.

In contrast, the proportion of salt tends to have a relatively small influence. From 2Ca to 2Ca# the fraction of CaBr₂ is doubled, but the effect on the holding powers and the gel fraction is relatively small. The gel fraction falls by about 2% and the holding powers tend to deteriorate. The errors are within the bounds of measurement inaccuracies. The picture that emerges for 3Ca and 3Ca# is similar.

In summary, the production of high-shear-strength PSAs using the holmelt technology is facilitated by the addition of metal salts.

Test Methods

The following test methods were employed in order to evaluate the performance properties of the PSAs produced.

Shear Strength (Test A)

Following its transfer lamination to aluminum foil, a strip of the adhesive tape, 13 mm wide, was applied to a smooth steel surface which had been cleaned three times with acetone and once with isopropanol. The area of application was 20*13 mm (length*width). Subsequently, with an applied pressure of 2 kg, the adhesive tape was pressed onto the steel support four times. At room temperature or at 80° C. a 1 kg weight was attached to the adhesive tape. The holding powers measured are reported in minutes and correspond to the average from three measurements.

180° Bond Strength Test (Test B)

A strip 20 mm wide of an acrylate PSA coated onto a polyester was applied to steel plates. The PSA strip was pressed onto the substrate twice using a 2 kg weight.

Immediately thereafter the adhesive tape was peeled from the substrate at 300 mm/min and at a 180° angle. The steel plates were washed twice with acetone and once with isopropanol. The results of measurement are reported in N/cm and are averaged from three measurements. All measurements were carried out at room temperature under climatically standardized conditions.

Determining the Gel Fraction (Test C)

After careful drying, the solvent-free adhesive samples are welded into a nonwoven pouch of polyethylene (Tyvek web). The gel index is determined from the difference in the sample weights before and after extraction with toluene.

Rheology (Test D)

The measurements were carried out using the Dynamic Stress Rheometer from Rheometrics. A frequency sweep was carried out at 25° C. from 0.1 to 100 rad/s. The temperature sweep was measured at 10 rad/s in a temperature range from −25° C. to 130° C. All experiments were conducted with a parallel plate arrangement.

Gel Permeation Chromatography GPC (Test E)

The average molecular weight M_{w} and the polydispersity PD were determined by way of gel permeation chromatography. The eluent used was THF containing 0.1% by volume trifluoroacetic acid. The measurement took place at 25° C. The precolumn used was PSS-SDV, 5μ, 10³ Å, ID 8.0 mm×50 mm. For separation the columns used were PSS-SDV, 5μ, 10³ and also 10⁵ and 10⁶ each with an ID 8.0 mm×300 mm. The sample concentration was 4 g/l, the flow rate 1.0 ml per minute. Measurement was carried out against PMMA standards.

For electron beam crosslinking an instrument from Electron Crosslinking AB, Halmstad, Sweden was used. The coated PSA tape was guided through via a chillroll, which is present as standard, beneath the Lenard window of the accelerator. In the zone of irradiation the atmospheric oxygen was displaced by flushing with pure nitrogen. The belt speed was 10 m/min in each case. Transirradiation took place with an acceleration voltage of 180 kV.

Preparation of the Samples

### Example 1

A 2-L glass reactor conventional for free-radical polymerization was charged with 8 g of acrylic acid, 178 g of n-butyl acrylate, 178 g of 2-ethylhexyl acrylate, 4 g of maleic anhydride, 32 g of N-tert-butylacrylamide and 300 g of acetone/isopropanol (97:3). After the nitrogen gas had been passed through the reactor for 45 minutes with stirring the reactor was heated to 58° C. and 0.2 g of Vazo 67 was added. Thereafter the external heating bath was heated to 75° C. and the reaction was carried out constantly at this external temperature. After a reaction time of 1.5 h a further 0.2 g of Vazo 67 was added. After 3 h and 6 h dilution took place with, in each case, 150 g of acetone/isopropanol mixture. To reduce the residual initiators, after 10 h a solution of 0.4 g of Perkadox 16 in 10 g of acetone was added dropwise. The reaction was terminated after a reaction time of 22 h, followed by cooling to room temperature. The adhesive was coated onto a siliconized release paper backing, dried in an oven at 120° C., and then cured with EB at different doses (0, 20 or 30 kGy). This was followed by testing by test methods A, B and C. Furthermore, an uncrosslinked sample was prepared for test method D.

### Example 2

The procedure of example 1 was repeated. Polymerization was carried out using 4 g of acrylic acid, 48 g of N-tert-butylacrylamide, 344 g of 2-ethylhexyl acrylate and 4 g of maleic anhydride. The amount of solvent and initiator were retained. The pure polyacrylate was cured by being treated with 20 or 30 kGy dose on the release paper backing. For analysis, test methods A, B and C were carried out.

### Example 3

The procedure of example 1 was repeated. Polymerization was carried out using 12 g of acrylic acid, 240 g of 2-ethylhexyl acrylate, 120 g of n-butyl acrylate, 32 g of N-tert-butylacrylamide and 4 g of maleic anhydride. The amounts of solvent and initiator were retained. The adhesive was coated onto a siliconized adhesive paper backing, dried in an oven at 120° C. and then cured with EB at different doses (20 to 30 kGy). This was followed by testing, using test methods A, B and C.

### Example 1Li

100 g of the polymer of example 1 (based on solids content) were mixed with 1.8 g of LiBr at room temperature and after 3 hours of stirring the mixture was applied to the release paper backing. Evaporation of the solvent at 120° C. was followed by curing with EB at different doses (0, 20 or 30 kGy). This was followed in turn by testing, using test methods A, B and C. In addition an uncrosslinked sample was prepared for test method D.

### Example 1Na

100 g of the polymer of example 1 (based on solids content) were mixed with 3.0 g of LiBr at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C. In addition an uncrosslinked sample was prepared for test method D.

### Example 1Ca

100 g of the polymer of example 1 (based on solids content) were mixed with 3.9 g of CaBr₂ at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C. In addition an uncrosslinked sample was prepared for test method D.

### Example 1Zn

100 g of the polymer of example 1 (based on solids content) were mixed with 2.8 g of ZnBr₂ at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C. In addition an uncrosslinked sample was prepared for test method D.

### Example 2Ca

100 g of the polymer of example 2 (based on solids content) were mixed with 2.0 g of CaBr₂ at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C.

### Example 2Ca#

100 g of the polymer of example 2 (based on solids content) were mixed with 4.0 g of CaBr₂ at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C.

### Example 3Ca

100 g of the polymer of example 3 (based on solids content) were mixed with 5.8 g of CaBr₂ at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C.

### Example 3Ca#

100 g of the polymer of example 3 (based on solids content) were mixed with 2.9 g of CaBr₂ at room temperature and after 3 hours of stirring the mixture was applied to the release paper backing. Evaporation of the solvent at 120° C. was followed by curing with EB at different doses (20 or 30 kGy). This was followed in turn by testing, using test methods A, B and C.

1. A pressure-sensitive adhesive comprising at least 50% by weight of one or more copolymers of:
(A) acrylic and/or methacrylic acid derivatives represented by the formula
CH₂═CH(R₁)(COOR₂)
where R₁=H or CH₃ and R₂=an alkyl chain having 1-20 carbon atoms,
in an amount of 42-96.5 percent by weight of copolymer;
(B) vinyl compounds, acrylates, methacrylates containing one or more carboxylic acid groups, in an amount of 0.5 to 8 percent by weight of copolymer,
(C) vinyl compounds containing functional groups in an amount of 0-30 percent by weight of copolymer,
(D) N-tert-butylacrylamide, in an amount of 3-20 percent by weight of copolymer;
and also at least one monovalent or divalent metal salt, metal oxide and/or metal hydroxide which is soluble in at least one of said copolymers.

2. The pressure-sensitive adhesive of claim 1, wherein said at least one polymer-soluble monovalent or divalent metal salt, metal oxide and/or metal hydroxide is present in a molar ratio of 1:5 to 5:1 with respect to the carboxylic acid in the overall polymer content.

3. The pressure-sensitive adhesive of claim 1, wherein the salt or salts are selected from groups I A, II A, II B, I B and IV B of the Periodic Table.

4. The pressure-sensitive adhesive of claim 1, wherein the amount of the salt is between 0.25 to 8 weight %, relative to the polyacrylate.

5. The pressure-sensitive adhesive of claim 1, wherein the vinyl compound/s is/are selected from the group consisting of maleic anhydride, styrene, styrene derivatives, vinyl acetate, acrylated photoinitiators, and tetrahydrofuryl acrylates.

6. The pressure-sensitive adhesive of claim 1, further comprising a a UV- or EB-activable crosslinker.

7. The pressure-sensitive adhesive of claim 1, comprising further additives selected from the group consisting of resins, plasticizers and fillers.

8. The pressure-sensitive adhesive of claim 1, blended with at least one further polymer or copolymer.

9. A pressure-sensitive adhesive article having a backing coated on at least one side in regions with the pressure-sensitive adhesive of claim 1.

10. The pressure-sensitive adhesive article of claim 9, wherein said backing is in sheet or tape form and the pressure-sensitive adhesive article is a pressure-sensitive adhesive sheet or pressure-sensitive adhesive tape.

11. A method of applying the pressure-sensitive adhesive of claim 5 to a backing, wherein said pressure-sensitive adhesive is applied in the melt and then UV-cured.

12. A method of applying the pressure-sensitive adhesive of claim 5 to a backing, wherein said pressure-sensitive adhesive is applied in the melt and then electron beam-cured (EBC-treated).

13. The method of claim 12, wherein the dose for the electron beam curing of the pressure-sensitive adhesive tapes is between 10 and 100 kGy, for an acceleration voltage of between 80 and 300 kV.

14. The pressure-sensitive adhesive of claim 1, wherein said functional groups of said vinyl compounds containing functional groups are selected from the group consisting of hydroxyl groups, sulfonic acid groups, ester groups, anhydride groups, epoxy groups, photoinitiators, amide groups, amino groups, aromatics, heteroaromatics, heterocycles and ethers.

15. The pressure-sensitive adhesive of claim 3, wherein said salts are selected from the group consisting of salts, oxides, hydroxides and/or alkoxides of the metals lithium, sodium, potassium, calcium, magnesium, titanium, zinc, zirconium, barium, cadmium, strontium.

16. The pressure-sensitive adhesive of claim 15, wherein said salts are halides, silicates, or salts of organic acids of said metals.

17. The pressure-sensitive adhesive of claim 4, wherein said amount of said salt is between 3 and 6 weight %.

18. The pressure-sensitive adhesive of claim 8, wherein said further polymer or copolymer is itself pressure-sensitively adhesive.

19. The method of claim 13, wherein said dose is 15 to 35 kGy.

20. The method of claim 19, wherein said dose is about 20 kGy.
